(19) United States
(12) Patent Application Publication
(10) Pub. No.: US 2018/0359547 A1
(43) Pub. Date: Dec. 13, 2018

(54) A SPEAKER ENCLOSURE AND SPEAKER

(71) Applicant: TGI TECHNOLOGY PTE LTD, Singapore (SG)

(72) Inventor: Shihuang LI, Singapore (SG)

(21) Appl. No.: 15/779,785

(22) PCT Filed: Nov. 15, 2016
(86) PCT No.: PCT/SG2016/050565

§ 371 Date: May 29, 2018

(30) Foreign Application Priority Data
Nov. 27, 2015 (CN) 201510849178.8

(51) Int. Cl. H04R 1/02; H04R 31/00

(52) U.S. Cl. CPC H04R 1/025; H04R 31/00; H04R 1/021

(57) ABSTRACT

The present invention discloses a speaker enclosure, in particularly a blown molded hollow pressure vessel. The present invention discloses a speaker enclosure, which is formed at once and sealed better. The thickness of the enclosure can be very thin and hence reduce the weight of the speaker. The present invention discloses a speaker enclosure, which can use many of the existing products to replace the traditional speaker enclosure. The present invention discloses a speaker enclosure, which its audible unit directly connects to the blow opening tightly. The present invention discloses a speaker enclosure, which its audible unit is provided with a seal. When the audible unit and speaker enclosure are assembled, the seal and enclosure opening thereby are completely tight assembled together.

### FIELD OF THE INVENTION

The present invention relates to a speaker enclosure and speaker.

### BACKGROUND ART

Traditional speaker comprises an enclosure and an audible unit. The enclosure provides a sealed chamber for the audible unit; when the audible unit emitting sound, the air in the cavity is driven and resonates. Therefore, the enclosure needs to take into account the resistance to the internal air pressure. For traditional design, it is common to produce thick and heavy enclosure to increase the resistance to its internal air pressure. The drawback of this approach is the great increase of the enclosure's own weight, resulting in increase of cost and lack of enclosure's mobility.

### DESCRIPTION OF THE INVENTION

The major technical problem to be solved by the present invention is to disclose a speaker enclosure, which is formed at once and sealed better. The thickness of the enclosure can be very thin and hence reduce the weight of the speaker.

Another technical problem to be solved by the present invention is to disclose a speaker enclosure, which can use many of the existing products to replace the traditional speaker enclosure.

Another technical problem to be solved by the present invention is to disclose a speaker with the above mentioned enclosure, which the audible unit directly connects to the blow opening tightly.

Another technical problem to be solved by the present invention is to provide a speaker with the above mentioned enclosure having a drive circuit installed on a blow opening of the enclosure, and the enclosure that has been cut to provide a further opening for an audible unit to be installed thereto.

Another technical problem to be solved by the present invention is to disclose a speaker with the above mentioned enclosure, which its audible unit is provided with a seal. When the audible unit and speaker enclosure are assembled, the seal and enclosure opening thereby are completely tight assembled together.

In order to solve the technical problem mentioned above, the present invention discloses a speaker enclosure, in particularly a blow molded hollow pressure vessel.

In a preferred embodiment: the enclosure material is plastic.

In a preferred embodiment: the enclosure material is glass and the thickness of the enclosure is less than 5 mm.

In a preferred embodiment: the hollow pressure vessel is spherical.

In a preferred embodiment: the hollow pressure vessel consists inverted tube.

The present invention also discloses a speaker: comprising audible unit and the enclosure as mentioned above.

In a preferred embodiment: the blow opening of the enclosure is blown together with the screw thread that is closely connected to the audible unit.

In a preferred embodiment: part of the enclosure and the cutting port in the direction perpendicular to the blow opening are removed, so that the enclosure has an opening connected to the audible unit.

In a preferred embodiment: the opening is closely connected to the audible unit with a seal.

In a preferred embodiment: the seal is a soft elastic ring wrapped at the side of the audible unit, wherein the inner periphery of the soft elastic ring has a rigid elastic ring with elastic force smaller than that soft elastic ring; multiple seal rings are distributed at the outer periphery of the soft elastic ring in parallel with the axial direction of the soft elastic ring; when the audible unit is placed in the hollow pressure vessel, the soft elastic ring is simultaneously subjected to compressive force of the opening and force limit of the rigid elastic ring, so that the seal ring and the opening fit with each other and sealed.

In a preferred embodiment: the outer diameter of the multiple seal rings can be similar or different.

In a preferred embodiment: both sides of the acoustic pot of the audible unit has an inserting rib which fits with the blow opening, and the side where the rib is connected to the blow opening has an inclined surface.

In a preferred embodiment: the blow opening extends the rim during blowing, respectively, to both sides of the blow opening; and both sides of the acoustic pot of the audible unit have elastic buckles fitting with the rim.

In a preferred embodiment: in particularly also comprises a bracket, wherein the bracket comprises a support bar, its ends are connected to the speaker enclosure swing through a connecting rod.

In a preferred embodiment: the connecting point of the connecting rod and the enclosure swing is located on the same axis as the center of gravity of the speaker.

In a preferred embodiment: the audible unit is loudspeaker or compact audio module.

In a preferred embodiment: the hollow pressure vessel has double inner wall, and the layer between double inner wall is vacuum layer.

In a preferred embodiment: the outer wall of the hollow pressure vessel is equipped with a solar energy-electric energy conversion panel.

In a preferred embodiment: the inner wall of the hollow pressure vessel is equipped with a support mechanism. The support mechanism has a honeycomb structure which is spliced by regular hexagons.

Compared to the existing technology, the technology of the present invention has the following advantages:

1. The present invention discloses a speaker enclosure, wherein the pressure vessel of the enclosure is formed by at once blowing, which due to the pressure vessel characteristic of the enclosure, it is not necessary to increase the thickness of the enclosure in order to improve the resistance of the enclosure to the internal air pressure. At the same time due to the use of blowing process used by the enclosure, it is possible to make thin-walled enclosure with the process features. Therefore, these two features allow the manufacture of light and thin enclosure, and large-size speakers are able to have good portability which was unthinkable in the past. And when blown at once, beside the blow opening the enclosure has no other gaps, and the audible unit is happened to be installed at the blow opening, so it is not necessary to make additional sealing to guarantee the overall sealing of the speaker. Pressure is easier to ensure the rigidity of the enclosure, thus avoiding the possibility of many combinations of background noise.

2. The present invention discloses a speaker enclosure, where is made of the common glass or plastic which can use many of the existing products to replace the traditional speaker enclosure. The production cost for enclosure design can be reduced, also allow consumers to customize personalized speaker. It also allows a lot of things to have two combined features, such as sealed jars, besides the usual storage feature, consumers can seal the audible unit with the opening of sealed jars, to obtain a complete set of speaker.

3. The present invention discloses a speaker with above mentioned enclosure, wherein the audible unit directly connects to the blow opening tightly, such as blow opening of the enclosure is blown together with the screw thread that makes a sealed connection with the audible unit.

4. The present invention discloses a speaker with above mentioned enclosure, wherein part of the enclosure and the cutting port in the direction perpendicular to the blow opening are removed, so that the enclosure has an opening connected to the audible unit. Its audible unit is provided with a seal. When the audible unit and the enclosure are assembled, the seal and enclosure opening thereby are completely tight assembled together.

5. The present invention discloses a speaker with above mentioned enclosure, which its seal is soft elastic ring with multiple seal rings at the outer periphery and the diameter of each seal ring is different. After being set like this, even if there is a slight deviation between the used vessel opening and installation dimensions of the audible unit, with different diameter of the seal ring, there should be a seal ring which can be fitted with the opening for a sealed installation. Thus improving the installation tolerance.

### DESCRIPTION OF THE DRAWINGS

FIG. 1 is a cross-sectional view of the preferred embodiment 1 of the present invention;

FIG. 2 is a cross-sectional view of the enclosure according to the preferred embodiment 1 of the present invention;

FIG. 3 is a cross-sectional view of the enclosure according to the preferred embodiment 2 of the present invention;

FIG. 4 is a cross-sectional view of the preferred embodiment 3 of the present invention;

FIG. 5 is a cross-sectional view of the enclosure according to the preferred embodiment 3 of the present invention;

FIG. 6 is a installation diagram of the audible unit and enclosure according to the preferred embodiment 3 of the present invention;

FIG. 7 is a cross-sectional view of the preferred embodiment 4 of the present invention;

FIG. 8 is a top view of the enclosure according to the preferred embodiment 5 of the present invention;

FIG. 9 is a cross-sectional view of the enclosure according to the preferred embodiment 5 of the present invention;

FIG. 10 is a cross-sectional view of the preferred embodiment 5 of the present invention;

FIG. 11 is a cross-sectional view of the preferred embodiment 6 of the present invention;

FIG. 12 is a schematic diagram before the audible unit level ahead according to the preferred embodiment 6 of the present invention;

FIG. 13 is a schematic diagram before the audible unit level upward according to the preferred embodiment 6 of the present invention;

FIG. 14 is a schematic diagram of suspension according to the preferred embodiment 6 of the present invention;

FIG. 15 is a cutaway view to the preferred embodiment 7 of the present invention.

### DETAILED DESCRIPTIONS

Below drawings and detailed descriptions explain further the present invention.

### Embodiment 1

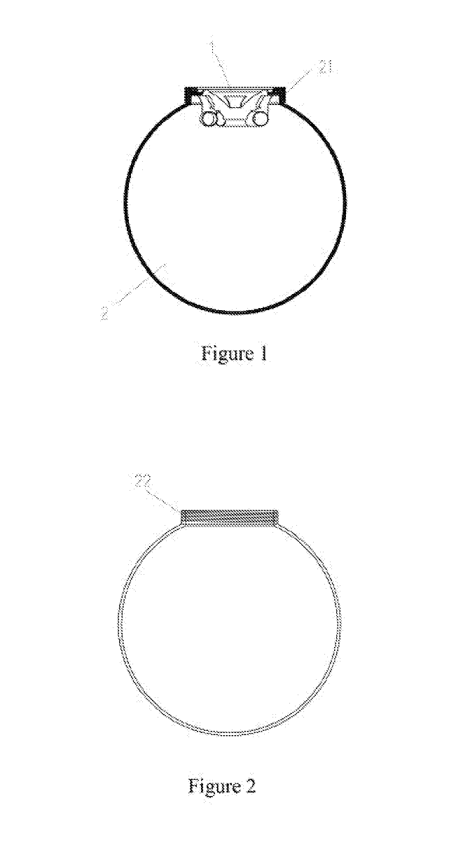

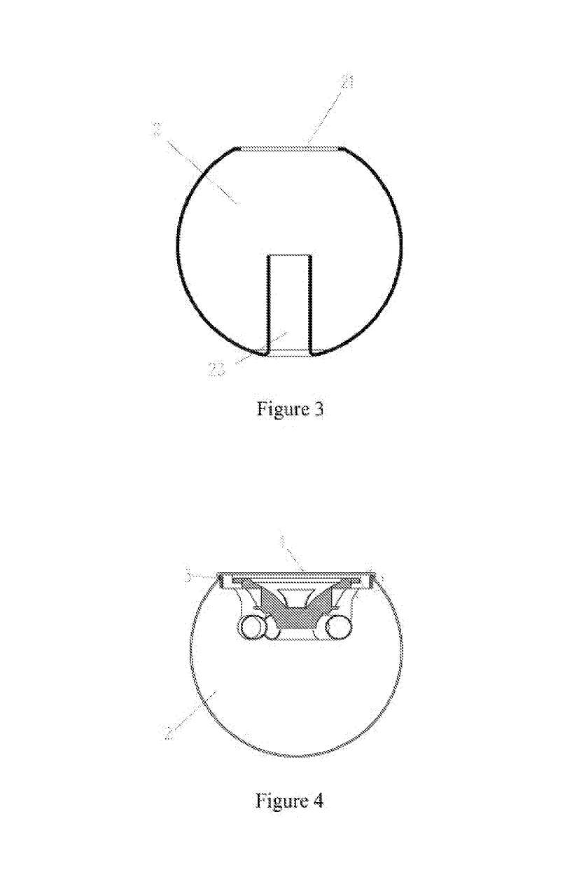

Refer to FIG. 1-2, a speaker: comprising the audible unit 1 and enclosure 2. Wherein the enclosure 2 is a blown molded hollow pressure vessel. In this embodiment, the hollow pressure vessel material is glass, spherical shape, and the thickness of a sphere is 5 mm. Of course, the enclosure can also be formed as a blow molded plastic enclosure, and the characteristics are same as the glass enclosure, not further descriptions needed.

Due to the pressure vessel characteristic of the enclosure 2, it is not necessary to increase the thickness of the enclosure 2 in order to improve the resistance of the enclosure to the internal air pressure. At the same time due to the use of blowing process used by the enclosure 2, it is possible to make thin-walled enclosure 2 with the process features. Therefore, these two features allow the manufacture of light and thin enclosure, in this embodiment, the thickness of enclosure 2 is only 5 mm.

Regarding the use of large-sized audible unit of the speaker, it is necessary to use large-sized enclosure in order to match this large-sized of the audible unit for traditional design. And in order to reduce the impact of the internal pressure to the enclosure as well as to avoid the resonance, the enclosure must be very heavy. This causes that large-sized speaker is completely not portable. Therefore, the present invention has overcome these technical prejudices, so that the weight of large-sized speakers greatly is being reduced and large speakers can also have certain degree of portability.

Other than that, when the enclosure 2 is blown molded at once, beside the blow opening 21 the enclosure 2 has no other gaps, and the audible unit 1 is happened to be installed at the blow opening 21, so it is not necessary to make additional sealing to guarantee the overall sealing of the speaker.

In order to tightly connect the audible unit 1 and the enclosure 2, in this embodiment, the blow opening 21 of the enclosure 2 is blown together with the screw thread 22 that is closely connected to the audible unit 1. With the screw thread 22, the blow opening 21 can make a sealed connection with the audible unit 1. This kind of connection is simple, reliable and very easy in assembly and disassembly.

In this embodiment: the audible unit 1 is loudspeaker or compact audio module.

Furthermore, the hollow pressure vessel has double inner wall, and the layer between double inner wall is vacuum layer. So that the enclosure 2 can have good thermal insulation properties. When the enclosure 2 is used as a vessel, it can keep food and water warm, which further enrich its function.

The outer wall of the hollow pressure vessel is equipped with a solar energy-electric energy conversion panel. When the hollow pressure vessel is used as a vase, at this time it can be charged because its location of placement must be exposed to the sun. So when using it as a speaker you do not need external power supply, which is very convenient.

The inner wall of the hollow pressure vessel is equipped with a support mechanism. The support mechanism has a honeycomb structure which is spliced by regular hexagons. Since the strength of the honeycomb structure is very high, so the support strength to the inner wall of the hollow pressure vessel is sufficiently strong, therefore the inner wall can be very thin, and hence greatly reduce the weight of the hollow pressure vessel.

### Embodiment 2

Refer to FIG. 3, the difference of this embodiment and the embodiment 1 is: the hollow pressure vessel has an inverted tube 23 in the opposite direction as the blow opening 21, thereby forming an inverted speaker. It is needed to be specified that the form of the inverted tube 23 is not limited to the one described in embodiments. As long as it is a common inverted tube that can meet the blowing requirements, it can be easily substituted in this embodiment, it is unnecessary to go into details.

### Embodiment 3

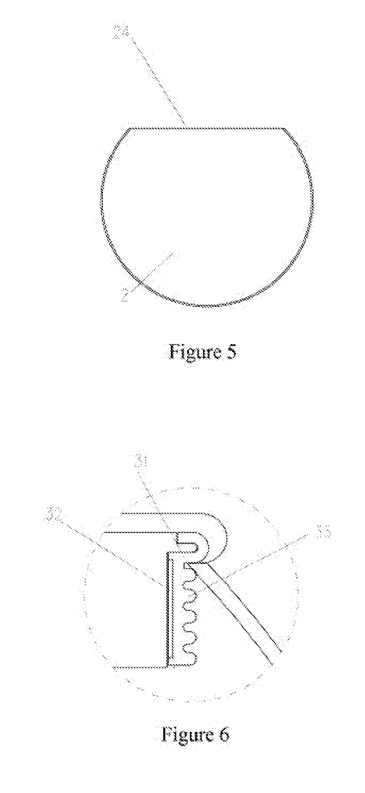

Refer to FIG. 4-6, for the traditional speaker design, both enclosure and audible unit are considered to be inseparable, because the required drive circuit for audible unit must be installed on the enclosure. As the technology advances and develops, the drive circuit of audible unit and other components can be set directly at the audible unit. Therefore, the replacement of the speaker enclosure is possible.

In particularly for the present invention, there is a large number of blown pressure vessels in the market, such as sealed jars, lampshades, etc. If it is possible to make use of these existing pressure vessels to produce a complete speaker after installing it tightly to the audible unit, it will greatly reduce the production and design cost of the speaker for manufacturers and also give users a more personalized option.

However, for the structure in the embodiment 1, the opening of the enclosure must have screw thread to be installed with the audible unit which is definitely a big limitation. In order to get rid of this limitation, in this embodiment:

The audible unit 1 is connected by a seal 3 to the opening 23 of the enclosure 2, as the result of part of the enclosure and the cutting port in the direction perpendicular to the blow opening being removed, this opening 24 of the enclosure 2 larger than blow opening is formed.

The seal 3 is a soft elastic ring 31 wrapped at the side of the audible unit 1, wherein the inner periphery of the soft elastic ring 31 has a rigid elastic ring 32 with elastic force smaller than that soft elastic ring 31; multiple seal rings 33 are distributed at the outer periphery of the soft elastic ring 31 in parallel with the axial direction of the soft elastic ring 31; when the audible unit 1 is placed in the hollow pressure vessel, the soft elastic ring 31 is simultaneously subjected to compressive force of the opening 24 and force limit of the rigid elastic ring 32, so that the seal ring 33 and the opening 24 fit with each other and sealed.

After being set like this, with the seal 3 corresponding to the size and design of common hollow pressure vessel opening in the market, the user only needs to fit the seal of the corresponding size to the outer of the audible unit 1, and then insert the audible unit 1 into the hollow pressure vessel opening to complete the sealed installation and form a whole speaker. For manufacturers, they only need to produce audible unit 1 and seal 3 which greatly reduce the production cost. For users, the playability of speaker has been further increased. For example, if users want to listen music in the living room and need better sound quality, the audible unit 1 can be sealed with a large-sized enclosure; and when users want to listen music at outdoors and need better portability, the audible unit 1 can be sealed with a small-sized enclosure. These assembly and disassembly of audible unit 1 are very simple and hence the usage of speaker becomes diversified.

In this embodiment, the outer diameter of the multiple seal rings 33 are different. After being set like this, even if there is a slight deviation between the used vessel opening and installation dimensions of the audible unit 1, with different diameter of the seal ring 33, there should be a seal ring 33 which can be fitted with the opening for a sealed installation. Thus improving the installation tolerance.

### Embodiment 4

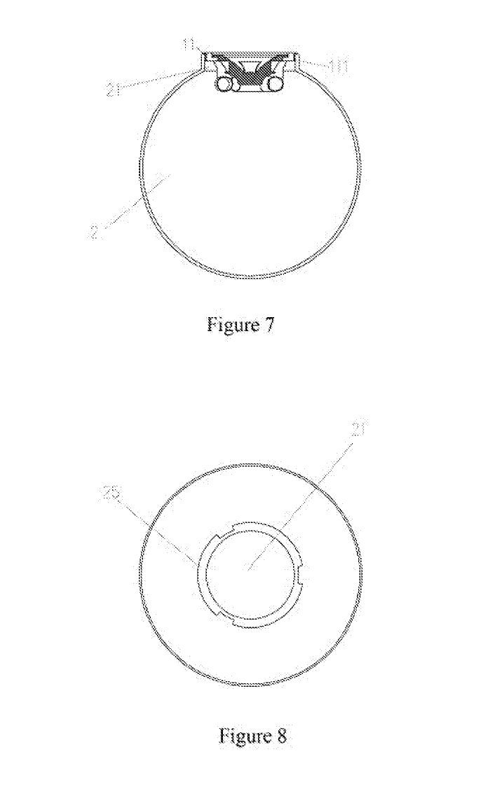

Refer to FIG. 7, the difference of this embodiment and the embodiment 1 is:

Both sides of the acoustic pot of the audible unit 1 has an inserting rib 11 which fits with the blow opening 21, and the side where the rib 11 is connected to the blow opening 21 has an inclined surface 111. Through the guiding of the inclined surface 111, the ribs 11 are inserted into the blow opening 21 to complete the sealing.

### Embodiment 5

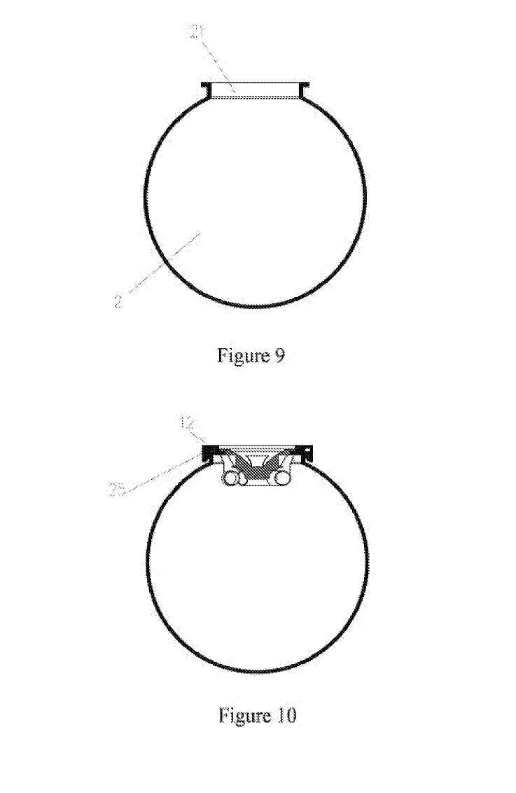

Refer to FIG. 8-10, the difference of this embodiment and the embodiment 1 is:

In a preferred embodiment: the blow opening 21 extends the rim 25 during blowing, respectively, to both sides of the blow opening 21; and both sides of the acoustic pot of the audible unit 1 have elastic buckles 12 fitting with the rim 25. Elastic buckle 12 is engaged with the rim 25, thus completing the sealed connection between audible unit 1 and enclosure 2.

In order to facilitate the engagement of the elastic bucket 12 with the rim 25, the rim 25 is provided with a notch. One side of the elastic buckle 12 is engaged at the notch and the other side with the rim, and then turn the audible unit 1, so that the elastic buckle 12 on both sides can be engaged with the rim respectively.

### Embodiment 6

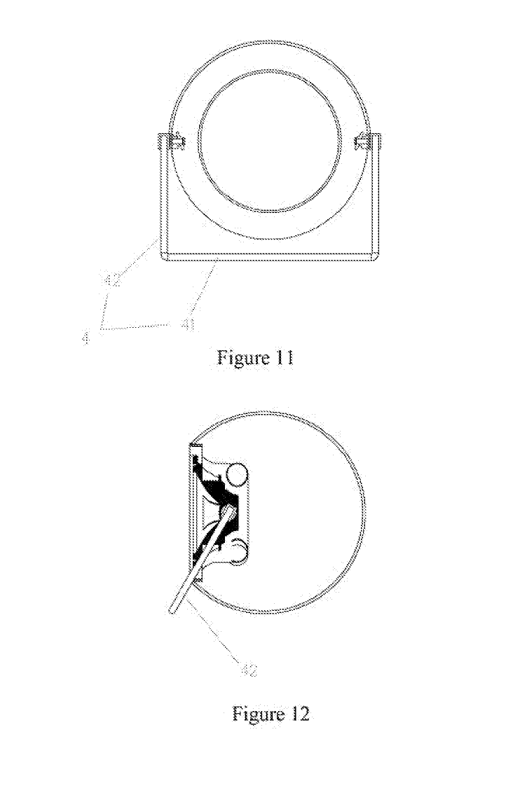

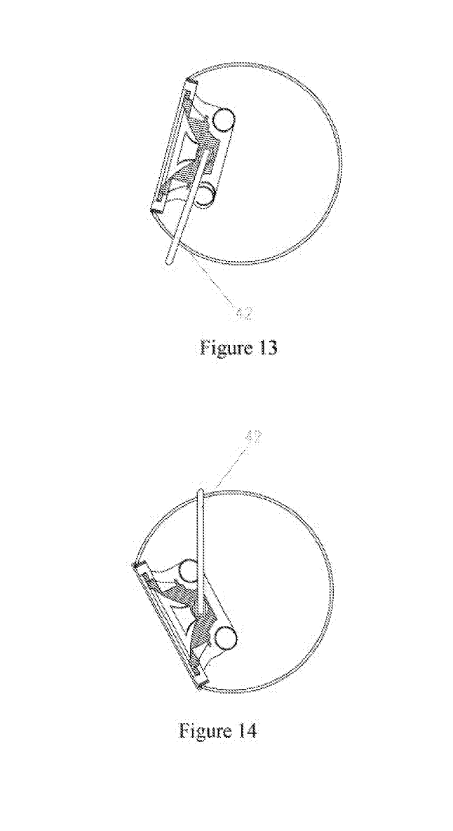

Refer to FIG. 11-14, the difference of this embodiment and the embodiment 1 is: in particularly also comprises a bracket 4, wherein the bracket 4 comprises a support bar 41, its ends are connected to the speaker enclosure 2 swing through a connecting rod 42.

The connecting point of the connecting rod 42 and the enclosure swing is located on the same axis as the center of gravity of the speaker.

Therefore, the center of gravity of the speaker is projected to the support bar 41, so that it can support the speaker, by adjusting the swinging angle of connecting rod 42 and speaker enclosure 2 to change the direction of audible unit 1.

And, the bracket 4 can also be considered as a loop for hanging. The speaker can be lifted through a connection of loop and hook.

### Embodiment 7

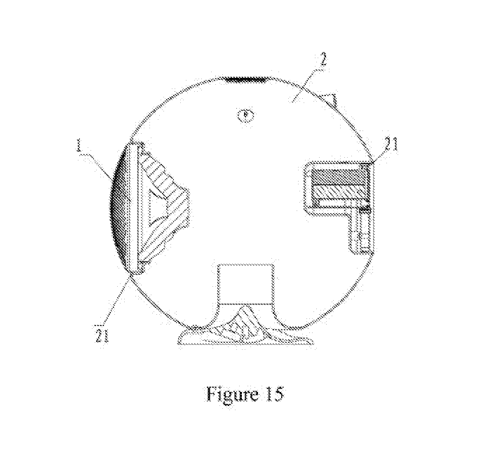

Referring to FIG. 15, a blow opening 21 of an enclosure 2 is being used to install a drive circuit of an audible unit 1, while the enclosure 2 has been cut to provide a further opening 22 for the audible unit to be installed therein. In this way the size of the further opening 22 can be cut according to the dimensions of the audible unit 1 and is not restricted by the dimensions of the blow opening 21.

The above descriptions are only the preferred embodiments of the present invention, but not limited to the scope of protection of the present invention. Any changes can be easily replaced or thought by any skilled technician in the disclosed technical scope of the present invention should fall within the scope of protection of the present invention. Therefore, the scope of protection of the present invention should be determined by the scope of the claims.

1. A speaker enclosure, comprising a blow molded hollow pressure vessel having at least one outer wall approximately 5 mm thick or thinner.

2. The speaker enclosure as claimed in claim 1 wherein the enclosure material is plastic.

3. The speaker enclosure as claimed in claim 1 wherein the enclosure material is glass.

4. The speaker enclosure as claimed in claim 1 wherein the hollow pressure vessel is spherical.

5. The speaker enclosure as claimed in claim 4 wherein the hollow pressure vessel consisting inverted tube.

6. A speaker, comprising an audible unit and the speaker enclosure as claimed in claim 1.

7. The speaker as claimed in claim 6 wherein a blow opening of the enclosure is formed with a screw thread that is closely connected to the audible unit.

8. The speaker as claimed in claim 6 wherein part of the enclosure and a cutting port in a direction perpendicular to the blow opening are removed, so that the enclosure has an opening connected to the audible unit.

9. The speaker as claimed in claim 8 wherein the opening is closely connected to the audible unit with a seal.

10. The speaker as claimed in claim 9 wherein the seal is a soft elastic ring wrapped at a side of the audible unit, wherein an inner periphery of the soft elastic ring has a rigid elastic ring with an elastic force smaller than that of the soft elastic ring; wherein multiple seal rings are distributed at an outer periphery of the soft elastic ring in parallel with an axial direction of the soft elastic ring; whereby the audible unit is placed in the hollow pressure vessel, and the soft elastic ring is simultaneously subjected to compressive force of the opening and a force limit of the rigid elastic ring, so that the seal ring and the opening fit with each other and seal.

11. The speaker as claimed in claim 10 wherein an outer diameter of the multiple seal rings are different.

12. The speaker as claimed in claim 6 wherein both sides of the an acoustic pot of the audible unit has an inserting rib which fits with the blow opening, and a side where the rib is connected to the blow opening has an inclined surface.

13. The speaker as claimed in claim 6 wherein a blow opening extends a rim during blowing, respectively, to both sides of the blow opening; and both sides of an acoustic pot of the audible unit have elastic buckles fitting with the rim.

14. The speaker as claimed in claim 6, in particularly also comprises a bracket, wherein the bracket comprises a support bar, its end are connected to the speaker enclosure swing through a connecting rod.

15. The speaker as claimed in claim 14 wherein a connecting point of the connecting rod and an enclosure swing are located on the same axis at a center of gravity of the speaker.

16. The speaker as claimed in claim 6 wherein the audible unit is a loudspeaker or a compact audio module.

17. The speaker as claimed in claim 6 wherein the hollow pressure vessel has a double inner wall, and the layer between double inner wall is vacuum layer.

18. The speaker as claimed in claim 6 wherein the outer wall of the hollow pressure vessel is equipped with a solar energy-electric energy conversion panel.

19. The speaker as claimed in claim 6 wherein the inner wall of the hollow pressure vessel is equipped with a support mechanism having a honeycomb structure which is spliced by regular hexagons.

20. The speaker as claimed in claim 6 wherein the drive circuit of audible unit is installed on a blow opening of the enclosure; the audible unit being sealingly connected to a further opening that has been cut onto an outer surface of the enclosure.
